(19) United States
(12) Patent Application Publication
(10) Pub. No.: US 2010/0048223 A1
(43) Pub. Date: Feb. 25, 2010

(54) ELECTRONIC DEVICE AND FUNCTION MODES SWITCHING METHOD THEREOF

(75) Inventor: CHIA-HUA WEI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/489,365

(22) Filed: Jun. 22, 2009

(30) Foreign Application Priority Data
Aug. 22, 2008 (CN) 200810304162.9

(51) Int. Cl. H04W 64/00

(52) U.S. Cl. 455/456.1

(57) ABSTRACT

An electronic device and function modes switching method include storing position information of various locations into a database, classifying the various locations into a plurality of location classifications, and setting a function mode of the electronic device corresponding to each location classification. The electronic device and function modes switching method further include acquiring position information of a current location of the electronic device, and activating a function mode of the electronic device according to a location classification of the current location of the electronic device.

### BACKGROUND

1. Technical Field

Embodiments of the present disclosure relate to electronic devices and function modes managing methods, and more particularly to an electronic device and function modes switching method.

2. Description of Related Art

Electronic devices (e.g., mobile phones) provide different function modes to select by users, such as a silence mode and a normal mode. However, some users may forget to change an appropriate function mode of the mobile phones when they move between different locations. For example, some users forget to change to the silence mode of the mobile phones when they walk into a theatre to see a movie. Sudden ring tones may disturb other spectators in the theatre.

What is needed, therefore, is an improved electronic device and function modes switching method.

### BRIEF DESCRIPTION OF THE DRAWINGS

FIG. 1 is a block diagram of one embodiment of an electronic device capable of switching function modes.

FIG. 2 is a schematic diagram of a list of position information of various locations.

FIG. 3 is a flowchart of one embodiment of a method for switching function modes of the electronic device of FIG. 1.

### DETAILED DESCRIPTION

All of the processes described may be embodied in, and fully automated via, functional code modules executed by one or more general purpose computers or processors. The code modules may be stored in any type of computer-readable medium or other storage device. Some or all of the methods may alternatively be embodied in specialized computer hardware or electronic apparatus.

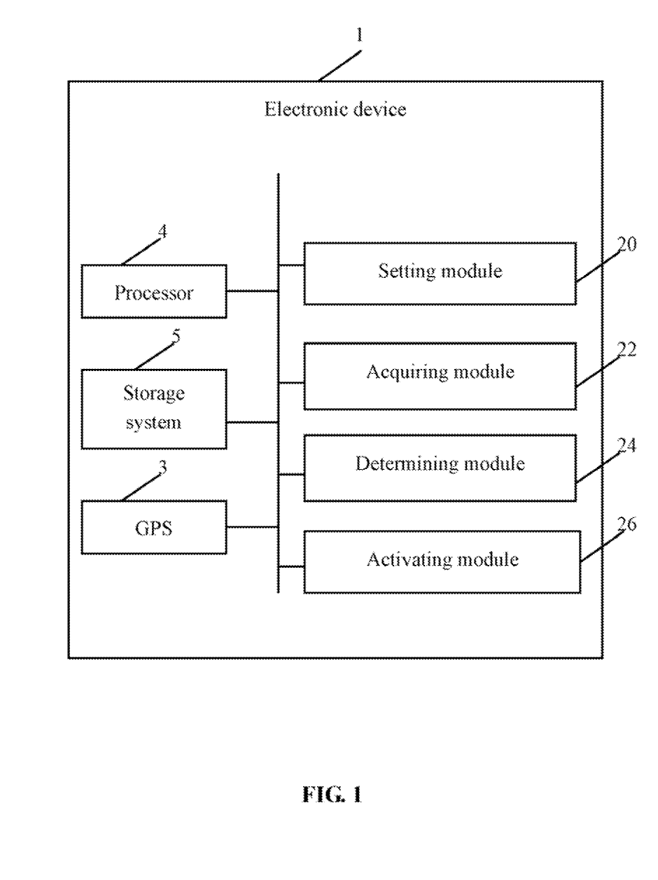

FIG. 1 is a block diagram of one embodiment of an electronic device 1 capable of switching function modes. The electronic device 1 may be a mobile phone, a personal digital assistant (PDA), or any other kind of computing device, for example.

The electronic device 1 may include a global position system (GPS) 3, a processor 4, and a storage system 5. The GPS 3 is operable to locate a position of the electronic device 1. The processor 4 executes one or more computerized operations of the electronic device 1 and other applications, to provide functions of the electronic device 1. The storage system 5 stores one or more programs, such as programs of an operating system, other applications of the electronic device 1, and various kinds of data, such as position information, images, function modes, etc. In one embodiment, the electronic device 1 may be a mobile phone, and the storage system 5 may be a memory of the electronic device 1 or an external storage card, such as a memory stick, a subscriber identification module (SIM) card, a smart media card, a compact flash card, or any other type of memory card.

In one embodiment, the electronic device 1 includes a setting module 20, an acquiring module 22, a determining module 24, and an activating module 26. The modules 20, 22, 24, and 26 may comprise one or more computerized operations to be executed by the processor 4 to perform one or more operations of the electronic device 1, such as switching function modes of the electronic device 1.

The setting module 20 creates a database in the storage system 5, and stores position information of various locations into the database. The position information of the various locations includes longitude, latitude, altitude, and/or a name of each location. The position information of a plurality of specified locations, such as an office, a meeting room, a library, a hospital, home, a park, a theater, an airdrome, for example, may be prestored into the database.

The setting module 20 also classifies the various locations into a plurality of location classifications, and sets a function mode of the electronic device corresponding to each location classification. In one embodiment, the plurality of location classifications may include a nonrestrictive classification, a voice restricted classification, and an electromagnetic restricted classification. For example, the locations in the nonrestrictive classification may include parks and bus stations, the locations in the voice restricted classification may include offices and libraries, and the locations in the electromagnetic restricted classification may include hospitals, for example.

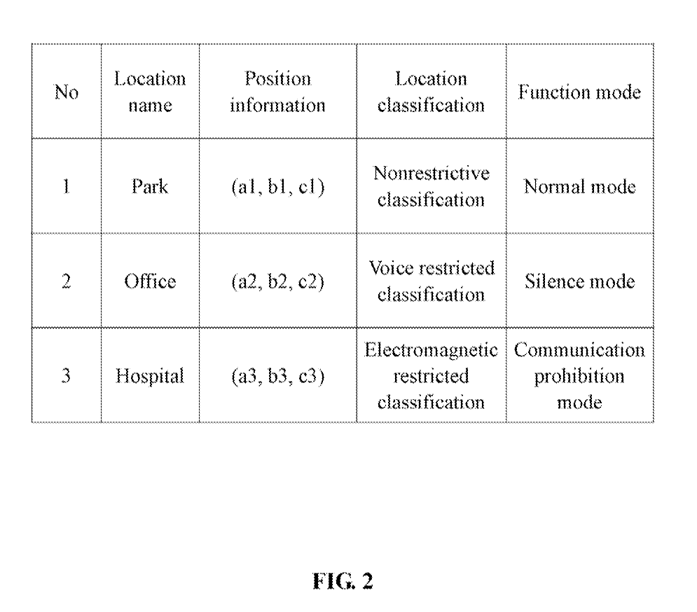

In one embodiment, the function modes may include a normal mode corresponding to the nonrestrictive classification, a silence mode corresponding to the voice restricted classification, and a communication prohibition mode corresponding to the electromagnetic restricted classification. Under the normal mode, a ring tone, a vibration, and/or other functions may be selected/activated. Under the silence mode, the ring tone is restricted and the vibration may be selected or restricted according to user requirements or predetermines. Under the electromagnetic restricted classification mode, phone calls are restricted. Referred to FIG. 2, a list of position information of the locations is shown. A location name, position information, a location classification, and a function mode of each location are listed.

The acquiring module 22 acquires position information of a current location of the electronic device 1 by using the GPS 3.

The determining module 24 determines if the database includes the acquired position information of the current location of the electronic device 1, and determines a location classification of the current location, if the database includes the acquired position information of the current location.

The activating module 26 determines a function mode of the electronic device 1 corresponding to the determined location classification, and determines if a current function mode of the electronic device 1 is the same as the determined function mode. If the current function mode of the electronic device 1 is the same as the determined function mode, the current function mode of the electronic device 1 is maintained. Otherwise, if the current function mode of the electronic device 1 is different from the determined function mode, the activating module 26 activates the determined function mode. For example, the activating module 26 may switch the current function mode of the electronic device 1 to the determined function mode.

The activating module 26 further activates/maintains the normal mode if the database does not include the acquired position information of the current location. In one embodiment, if position information of a location A is not included in the database, the location A may default to be in the nonrestrictive classification, thus the function mode corresponding to the location is the normal mode. In another embodiment, the location A also may default to be in another location classification.

For example, when a user of the electronic device 1 goes into a library, the activating module 26 may activate the silence mode of the electronic device 1 by determining that the library is in the voice restricted classification. In another example, when the user walks out from the library to a street, the determining module 24 determines that the database does not include any position information of the street, and the activating module 26 activates the normal mode of the electronic device 1.

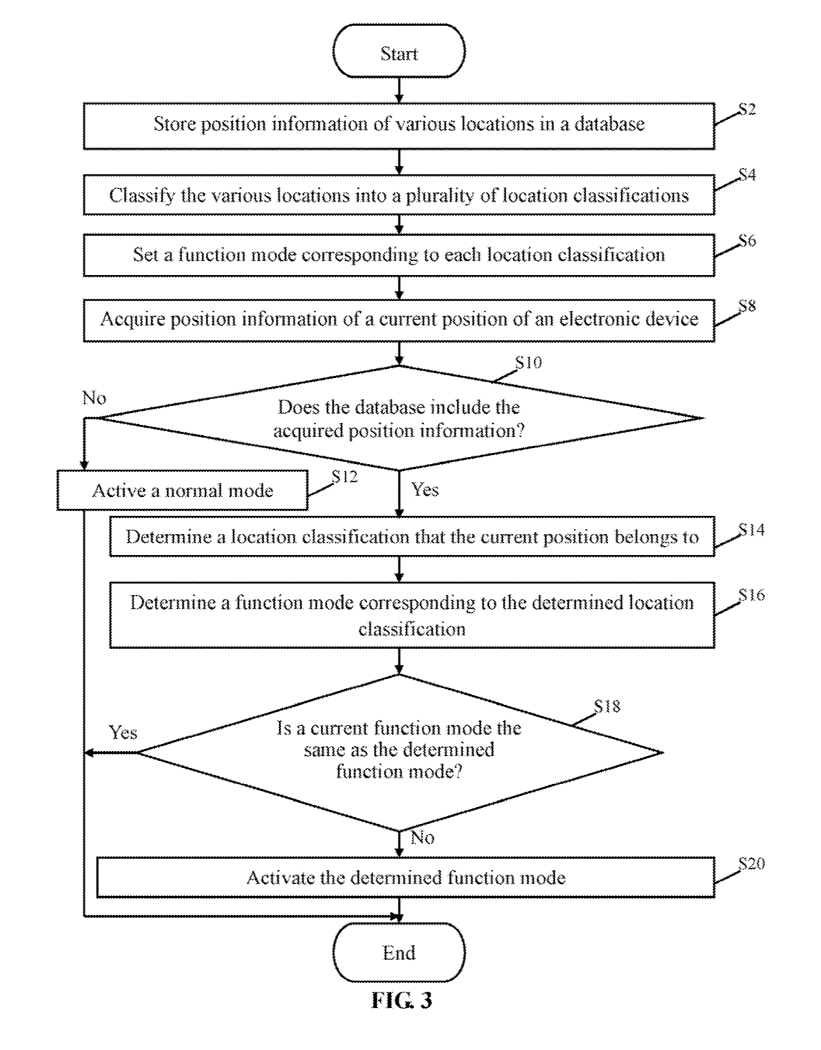

FIG. 3 is a flowchart of one embodiment of a method for switching function modes of an electronic device 1 of FIG. 1 Depending on the embodiment, additional blocks may be added, others removed, and the ordering of the blocks may be replaced.

In block S2, the setting module 20 creates a database in the storage system 5, and stores position information of various locations into the database. As mentioned about, the position information of the various locations may include, but not limited to longitude, latitude, altitude, and/or a name of each location.

In block S4, the setting module 20 classifies the various locations into a plurality of location classifications. As mentioned about, the plurality of location classifications may include a nonrestrictive classification, a voice restricted classification and an electromagnetic restricted classification.

In block S6, the setting module 20 sets a function mode of the electronic device corresponding to each location classification. The function modes may include a normal mode corresponding to the nonrestrictive classification, a silence mode corresponding to the voice restricted classification, and a communication prohibition mode corresponding to the electromagnetic restricted classification.

In block S8, the acquiring module 22 acquires position information of a current location of the electronic device 1 by using the GPS 3.

In block S10, the determining module 24 determines if the database includes the acquired position information of the current location of the electronic device 1. If the database does not include the acquired position information of the current location, in block S12, the activating module 26 activates the normal mode, and then the procedure ends.

If the database includes the position information of the current location, in block S14, the determining module 24 determines a location classification of the current location.

In block S16, the activating module 26 determines a function mode of the electronic device 1 corresponding to the determined location classification.

In block S18, the activating module 26 determines if a current function mode of the electronic device 1 is the same as the determined function mode. If the current function mode of the electronic device 1 is the same as the determined function mode, the procedure ends.

If the current function mode of the electronic device 1 is different from the determined function mode, in block S20, the activating module 26 activates the determined function mode, that is, the activating module 26 switches the current function mode of the electronic device 1 to the determined function mode.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for switching function modes of an electronic device, the electronic device comprising a global position system (GPS), the method comprising:
creating a database in a storage system of the electronic device, and storing position information of various locations into the database
classifying the various locations into a plurality of location classifications;
setting a function mode of the electronic device corresponding to each location classification;
acquiring position information of a current location of the electronic device by using the GPS;
determining if the database comprises the acquired position information of the current location;
determining a location classification of the current location, if the database comprises the acquired position information of the current location; and
activating a function mode of the electronic device corresponding to the determined location classification.

2. The method according to claim 1, wherein the position information of the locations comprises longitude, latitude, altitude, and/or a name of each location.

3. The method according to claim 1, wherein the plurality of location classifications comprise a nonrestrictive classification, a voice restricted classification and an electromagnetic restricted classification.

4. The method according to claim 3, wherein the locations in the nonrestrictive classification comprise parks, the locations in the voice restricted classification comprise offices and libraries, and the locations in the electromagnetic restricted classification comprise hospitals.

5. The method according to claim 3, wherein the function modes comprise a normal mode corresponding to the nonrestrictive classification, a silence mode corresponding to the voice restricted classification, and a communication prohibition mode corresponding to the electromagnetic restricted classification.

6. The method according to claim 5, further comprising:
activating the normal mode of the electronic device if the database does not comprise the acquired position information of the current location.

7. An electronic device, comprising:
a global position system (GPS);
a storage system;
at least one processor; and
one or more programs stored in the storage system and being executable by the at least one processor, the one or more programs comprising:
a setting module operable to create a database in the storage system and store position information of various locations into the database, classify the various locations into a plurality of location classifications, and set a function mode of the electronic device corresponding to each location classification;
an acquiring module operable to acquire position information of a current location of the electronic device by using the GPS;
a determining module operable to determine if the database comprises the acquired position information of the current location, and determine a location classification of the current location, if the database comprises the acquired position information of the current location;
an activating module operable to active a function mode of the electronic device corresponding to the determined location classification.

8. The electronic device according to claim 7, wherein the position information of the locations comprises longitude, latitude, altitude, and/or a name of each location.

9. The electronic device according to claim 7, wherein the plurality of location classifications comprise a nonrestrictive classification, a voice restricted classification and an electromagnetic restricted classification.

10. The electronic device according to claim 9, wherein the locations in the nonrestrictive classification comprise parks, the locations in the voice restricted classification comprise offices and libraries, and the locations in the electromagnetic restricted classification comprise hospitals.

11. The electronic device according to claim 9, wherein the function modes comprise a normal mode corresponding to the nonrestrictive classification, a silence mode corresponding to the voice restricted classification, and a communication prohibition mode corresponding to the electromagnetic restricted classification.

12. The electronic device according to claim 11, wherein the activating module is further operable to activate the normal mode of the electronic device if the database does not comprise the acquired position information of the current location.

13. A storage medium storing a set of instructions, the set of instructions capable of being executed by a processor to perform a method for switching function modes of an electronic device, the electronic device comprising a global position system (GPS), the method comprising:
creating a database in a storage system of the electronic device, and storing position information of various locations into the database
classifying the various locations into a plurality of location classifications;
setting a function mode of the electronic device corresponding to each location classification;
acquiring position information of a current location of the electronic device by using the GPS;
determining if the database comprises the acquired position information of the current location;
determining a location classification of the current location, if the database comprises the acquired position information of the current location; and
activating a function mode of the electronic device corresponding to the determined location classification.

14. The storage medium as claimed in claim 13, wherein the position information of the locations comprises longitude, latitude, altitude, and/or a name of each location.

15. The storage medium as claimed in claim 13, wherein the plurality of location classifications comprise a nonrestrictive classification, a voice restricted classification and an electromagnetic restricted classification.

16. The storage medium as claimed in claim 15, wherein the locations in the nonrestrictive classification comprise parks, the locations in the voice restricted classification comprise offices and libraries, and the locations in the electromagnetic restricted classification comprise hospitals.

17. The storage medium as claimed in claim 15, wherein the function modes comprise a normal mode corresponding to the nonrestrictive classification, a silence mode corresponding to the voice restricted classification, and a communication prohibition mode corresponding to the electromagnetic restricted classification.

18. The storage medium as claimed in claim 17, wherein the method further comprises:
activating the normal mode of the electronic device if the database does not comprise the acquired position information of the current location.
